(19) United States
(12) Patent Application Publication
(10) Pub. No.: US 2023/0211807 A1
(43) Pub. Date: Jul. 6, 2023

(54) AUTONOMOUS VEHICLE, STATION SYSTEM, AND METHOD FOR CONTROLLING DOOR THEREOF

(71) Applicants: Hyundai Motor Company, Seoul (KR); Kia Corporation, Seoul (KR)

(72) Inventors: Yim Ju Kang, Seoul (KR); Young II Na, Hwaseong (KR); Hoon Lee, Gunpo (KR); Jae Nam Yoo, lncheon (KR); Chang Jae Lee, Yongin (KR); Wan Jae Lee, Suwon (KR)

(21) Appl. No.: 17/974,896

(22) Filed: Oct. 27, 2022

(30) Foreign Application Priority Data
Dec. 31, 2021 (KR) 10-2021-0194262

(51) Int. Cl. B60W 60/00; B60W 50/14; E05F 15/73

(52) U.S. Cl. CPC B60W 60/00253; B60W 60/00274; B60W 50/14; E05F 15/73; B60W 2050/143; B60W 2050/146; B60W 2554/4045; B60W 2556/45

(57) ABSTRACT

The present disclosure relates to an autonomous vehicle, a station system, and a door control method for the autonomous vehicle. An exemplary embodiment of the present disclosure provides an autonomous vehicle, comprising a processor configured to control opening and closing of a door of the autonomous vehicle depending on existence of an object around the door of the autonomous vehicle and whether an object outside and inside a station reaches a boarding zone of the autonomous vehicle within a predetermined time when the autonomous vehicle is stopped, and a storage configured to store data and algorithms driven by the processor.

### CROSS-REFERENCE TO RELATED APPLICATION(S)

This application claims, under 35 U.S.C. § 119(a), the benefit of Korean Patent Application No. 10-2021-0194262, filed in the Korean Intellectual Property Office on Dec. 31, 2012, the disclosure of which is incorporated herein by reference in its entirety.

### BACKGROUND

### Technical Field

Embodiments of the present disclosure relate to an autonomous vehicle, a station system, and a door control method for the autonomous vehicle, more particularly, to a technique for automatically opening and closing a door of the autonomous vehicle at a station.

### Description of the Related Art

In the case of a shuttle bus with an autonomous driving system level 4 or higher, there is no longer a driver.

Accordingly, door control is performed manually in a current autonomous shuttle bus system. As such, a manual control system for a door of the autonomous shuttle bus makes it difficult to provide a shuttle service according to a situation, and there is a risk of an accident due to direct opening and closing of a service user.

As a result, there is a need to automatically control a door of an autonomous vehicle that was previously controlled by a vehicle driver.

The above information disclosed in this Background section is only for enhancement of understanding of the background of the disclosure, and therefore, it may contain information that does not form the existing technologies that are already known in this country to a person of ordinary skill in the art.

### SUMMARY

An exemplary embodiment of the present disclosure has been made in an effort to provide an autonomous vehicle, a station system, and a door control method for the autonomous vehicle, capable of automatically controlling a door of the autonomous vehicle by recognizing movement of objects outside and inside a station and an occupant of the autonomous vehicle, thereby providing safe getting on or off.

The technical objects of the present disclosure are not limited to the objects mentioned above, and other technical objects not mentioned can be clearly understood by those skilled in the art from the description of the claims.

An exemplary embodiment of the present disclosure provides an autonomous vehicle, including a processor configured to control opening and closing of a door of the autonomous vehicle depending on existence of an object around the door of the autonomous vehicle and whether an object outside and inside a station reaches a boarding zone of the autonomous vehicle within a predetermined time when the autonomous vehicle is stopped; and a storage configured to store data and algorithms driven by the processor.

In an exemplary embodiment, it may further comprise an interface device configured to display at least one of a vehicle status, a notification of whether the door is opened or closed, or a dangerous situation around the autonomous vehicle.

In an exemplary embodiment, the processor, may be configured to output a notification requesting a distance away from the door of the autonomous vehicle through the interface device when a surrounding object of the autonomous vehicle exists.

In an exemplary embodiment, it may further comprise a communication device configured to communicate with a station system, to transmit at least one of position information of the vehicle, boarding gate position information, or expected door opening or closing time information to the station system, and to receive from the station system whether an object outside and inside the station system reaches the boarding zone of the autonomous vehicle within a predetermined time or estimated time data for an object to arrive at the boarding zone of the autonomous vehicle.

In an exemplary embodiment, the processor may be configured to wait without opening the door when the autonomous vehicle stops and a probability that an object outside and inside the station will reach the boarding zone of the autonomous vehicle within a predetermined time before opening the door is greater than a predetermined reference level or when existence of the object outside and inside the station other than an occupant is confirmed.

In an exemplary embodiment, the processor may be configured to determine that the door is openable when the autonomous vehicle stops and a probability that an object outside and inside the station will reach the boarding zone of the autonomous vehicle within a predetermined time before opening the door is equal to or smaller than a predetermined reference level or when no object exists around outside of the door of the autonomous vehicle.

In an exemplary embodiment, the processor, after an occupant gets on or off the autonomous vehicle, may be configured to wait without closing the door even when an expected door closing time arrives in the case where a probability that an object outside and inside the station will reach the boarding zone of the autonomous vehicle within a predetermined time before closing the door is greater than a predetermined reference level or where existence of the object outside and inside the station other than an occupant is confirmed.

In an exemplary embodiment, the processor, after an occupant gets on or off the autonomous vehicle, may be configured to determine that the door is closeable when an expected door closing time arrives in the case where a probability that an object outside and inside the station will reach the boarding zone of the autonomous vehicle within a predetermined time before closing the door is equal to or smaller than a predetermined reference level or where it is determined that no object outside and inside the station other than an occupant exists.

In an exemplary embodiment, the interface device may be configured to notify an occupant of danger by outputting at least one of an LED blinking, an LED color depending on a situation, periodic buzzer notification, a warning sound, or a warning message within a predetermined time from a situation where the door is automatically or manually closed, or from a time the door is automatically opened or closed.

In an exemplary embodiment, the interface device may be configured to inform an occupant that getting on or off is possible through LED lighting or output of a guide message in a state where the door is fully opened.

An exemplary embodiment of the present disclosure provides a station system including: a processor configured to calculate information that is a determining factor in determining whether to open or close an automatic door of an autonomous vehicle by classifying a type of an object outside and inside a station, and predicting a movement path of the object; and a communication device configured to receive information necessary to calculate information serving as the determining factor from the autonomous vehicle, or to transmit the calculated information to the autonomous vehicle.

In an exemplary embodiment, the information that is the determining factor in determining whether to open or close the automatic door of the autonomous vehicle may comprise at least one of a probability that the object outside and inside the station will reach the boarding zone of the autonomous vehicle within a predetermined time, whether the object outside and inside the station reaches the boarding zone of the autonomous vehicle within a predetermined time, or an estimated arrival time of an object approaching the autonomous vehicle.

In an exemplary embodiment, the processor may be configured to classify the type of the object outside and inside the station, tracks the movement path of the object, or extracts a movement of the object.

In an exemplary embodiment, the processor may be configured to predict the movement path by using a movement of the object outside and inside the station as an input of an artificial intelligence algorithm.

In an exemplary embodiment, it may further comprise a sensing device configured to sense the object outside and inside the station.

In an exemplary embodiment, the processor may be configured to map a vehicle position received from the autonomous vehicle and a vehicle position sensed by the sensing device.

In an exemplary embodiment, the processor may be configured to receive a boarding gate position from the autonomous vehicle, recognizes the boarding gate position of the vehicle, and sets a boarding zone based on a received vehicle position.

In an exemplary embodiment, the processor may be configured to calculate a probability that or whether an object outside and outside a station arrives at a boarding zone of the autonomous vehicle within a predetermined time by using at least one of an expected door opening time of the autonomous vehicle received from the autonomous vehicle, an expected door closing time of the autonomous vehicle, a position of the vehicle, or a movement path of the object outside and inside the station, and

may be configured to calculate an estimated time of the object approaching the vehicle by using at least one of the position or the boarding zone of the autonomous vehicle received from the autonomous vehicle, or the movement path of the object outside and inside the station.

An exemplary embodiment of the present disclosure provides a door control method for an autonomous vehicle, including: determining whether an object surrounding a door of the autonomous vehicle exists when the autonomous vehicle is stopped; and controlling opening and closing of the door of the autonomous vehicle depending on existence of the object around the door and whether an object outside and inside a station reach a boarding zone of the autonomous vehicle within a predetermined time.

In an exemplary embodiment, it may further comprise displaying at least one of a vehicle status, whether the door is opened or closed, or an expected opening or closing notification of the door, or a dangerous situation around the autonomous vehicle.

The present technique may provide a system that automatically controls opening and closing of a door that enable an occupant to get on or off in an autonomous vehicle without a driver.

The present technique may provide safe getting on and off by automatically controlling the door of the autonomous vehicle by recognizing a movement of an object outside and inside a station and an occupant of the autonomous vehicle more widely and more accurately than a FOV range that can be recognized by the autonomous vehicle.

The present technique may provide safer and more convenient getting on and off through an interaction between a machine and an occupant by learning a movement of the occupant to recognize an intention of the movement, and then by introducing a new method in a boarding system, which previously consisted of an non-verbal interaction between the driver and the occupant as a method of predicting the next movement.

The present technique may provide a determination method that prevents human errors and depends on more accurate calculation without losing efficiency of a driving method of an city bus in which a driver currently exists.

In addition, various effects that can be directly or indirectly identified through this document may be provided.

### BRIEF DESCRIPTION OF THE DRAWINGS

FIG. 1 illustrates a block diagram showing a configuration of a system for automatically controlling a door of an autonomous vehicle according to an exemplary embodiment of the present disclosure.

FIG. 2 illustrates an example showing a sensor installation of a station according to an exemplary embodiment of the present disclosure.

FIG. 3 illustrates a station sensing range according to an exemplary embodiment of the present disclosure.

FIG. 4A illustrates an example of a screen in which a vehicle door is not opened according to an exemplary embodiment of the present disclosure.

FIG. 4B illustrates an example of a screen for notifying an occupant that a vehicle door is not opened according to an exemplary embodiment of the present disclosure.

FIG. 4C illustrates an example of a screen in which a vehicle door is not closed according to an exemplary embodiment of the present disclosure.

FIG. 5A to FIG. 5D illustrate an example for describing a process of calculating a probability that an occupant will board a vehicle at an autonomous driving station according to an exemplary embodiment of the present disclosure.

FIG. 6A illustrates an example of a transformer which is an artificial intelligence model that can be used as an example of a movement prediction method of an object according to an exemplary embodiment of the present disclosure.

FIG. 6B illustrates a view for describing a movement prediction process of an object using an artificial intelligence model other than a transformer according to an exemplary embodiment of the present disclosure.

FIG. 7 illustrates an operation flowchart of a system for a door automatic control for a vehicle according to an exemplary embodiment of the present disclosure.

FIG. 8 illustrates a flowchart showing a control method for automatically opening a door for a vehicle according to an exemplary embodiment of the present disclosure.

FIG. 9 illustrates a flowchart showing a control method for automatically closing a door for a vehicle according to an exemplary embodiment of the present disclosure.

FIG. 10 illustrates a computing system according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, some exemplary embodiments of the present disclosure will be described in detail with reference to exemplary drawings. It should be noted that in adding reference numerals to constituent elements of each drawing, the same constituent elements have the same reference numerals as possible even though they are indicated on different drawings. In addition, in describing exemplary embodiments of the present disclosure, when it is determined that detailed descriptions of related well-known configurations or functions interfere with understanding of the exemplary embodiments of the present disclosure, the detailed descriptions thereof will be omitted.

In describing constituent elements according to an exemplary embodiment of the present disclosure, terms such as first, second, A, B, (a), and (b) may be used. These terms are only for distinguishing the constituent elements from other constituent elements, and the nature, sequences, or orders of the constituent elements are not limited by the terms. In addition, all terms used herein including technical scientific terms have the same meanings as those which are generally understood by those skilled in the technical field to which the present disclosure pertains (those skilled in the art) unless they are differently defined. Terms defined in a generally used dictionary shall be construed to have meanings matching those in the context of a related art, and shall not be construed to have idealized or excessively formal meanings unless they are clearly defined in the present specification.

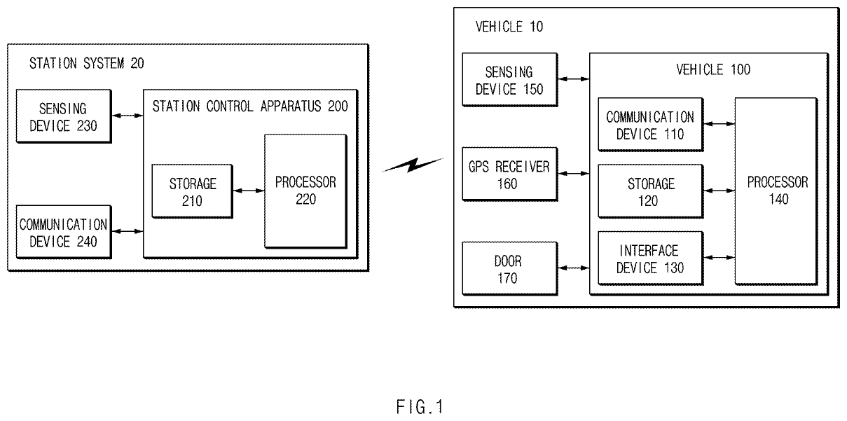

Hereinafter, exemplary embodiments of the present disclosure will be described in detail with reference to FIG. 1 to FIG. 10.

FIG. 1 illustrates a block diagram showing a configuration of a system for automatically controlling a door of an autonomous vehicle according to an exemplary embodiment of the present disclosure.

Referring to FIG. 1, the system according to the exemplary embodiment of the present disclosure may be configured to perform communication between a vehicle 10 and a station system 20 to automatically control a door of the vehicle 10. In this case, the vehicle 10 may comprise an autonomous vehicle.

The vehicle 10 may comprise an autonomous driving control apparatus 100, a sensing device 150, a GPS receiver 160, and a door 170.

The autonomous driving control apparatus 100 according to the exemplary embodiment of the present disclosure may be implemented inside the vehicle. In this case, the autonomous driving control apparatus 100 may be integrally formed with internal control units of the vehicle, or may be implemented as a separate device to be connected to control units of the vehicle by a separate connection means.

The autonomous driving control apparatus 100 may be configured to control opening and closing of the door 170 of the autonomous vehicle depending on whether there is an object surrounding the door 170 of the autonomous vehicle 10 when the autonomous vehicle 10 is stopped and whether objects outside and inside a station reach a boarding zone of the autonomous vehicle 10 within a predetermined time.

To this end, the autonomous driving control apparatus 100 may comprise a communication device 110, a storage 120, an interface device 130, and a processor 140.

The communication device 110 is a hardware device implemented with various electronic circuits to transmit and receive signals through a wireless or wired connection, and may be configured to transmit and receive information based on in-vehicle devices and in-vehicle network communication techniques. As an example, the in-vehicle network communication techniques may comprise controller area network (CAN) communication, local interconnect network (LIN) communication, flex-ray communication, Ethernet, wireless communication net (LTE), and the like.

In addition, the communication device 110 may be configured to perform communication by using a server, the station system 20, infrastructure, or third vehicles outside the vehicle, and the like through a wireless Internet access or short range communication technique. Herein, the wireless communication technique may comprise wireless LAN (WLAN), wireless broadband (Wibro), Wi-Fi, world Interoperability for microwave access (Wimax), etc. In addition, short-range communication technique may comprise bluetooth, ZigBee, ultra wideband (UWB), radio frequency identification (RFID), infrared data association (IrDA), and the like.

The communication device 110 may be configured to perform V2X communication. The V2X communication may comprise communication between vehicle and all entities such as V2V (vehicle-to-vehicle) communication which refers to communication between vehicles, V2I (vehicle to infrastructure) communication which refers to communication between a vehicle and an eNB or road side unit (RSU), V2P (vehicle-to-pedestrian) communication, which refers to communication between user equipment (UE) held by vehicles and individuals (pedestrians, cyclists, vehicle drivers, or passengers), and V2N (vehicle-to-network) communication.

As an example, the communication device 110 transmits a vehicle position, an expected door opening time, and an expected door closing time to the station system 20, and may be configured to receive position and probability data of an object, a door opening command signal, a door closing command signal, a door opening waiting signal, a door closing waiting signal, and the like from the station system 20. In this case, the door opening waiting signal may comprise a signal to wait before opening the door, and the door closing waiting signal may comprise a signal to wait before closing the door.

The storage 120 may be configured to store a sensing result of the sensing device 150, a receiving result of the GPS receiver 156, data and/or algorithms required for the processor 140 to operate, and the like. As an example, the storage device 120 may be configured to store the vehicle position, the expected door closing time, the expected door opening time, and the like.

The storage 120 may comprise a storage medium of at least one type among memories of types such as a flash memory, a hard disk, a micro, a card (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic memory (MRAM), a magnetic disk, and an optical disk.

The interface device 130 may comprise an input means for receiving a control command from a user and an output means for outputting an operation state of the apparatus 100 and results thereof. Herein, the input means may comprise a key button, and may comprise a mouse, a joystick, a jog shuttle, a stylus pen, and the like. In addition, the input means may comprise a soft key implemented on the display.

The interface device 130 may be implemented as a head-up display (HUD), a cluster, an audio video navigation (AVN), or a human machine interface (HM), a human machine interface (HMI).

The output device may comprise a display, and may also comprise a voice output means such as a speaker. In this case, when a touch sensor formed of a touch film, a touch sheet, or a touch pad is provided on the display, the display may be configured to operate as a touch screen, and may be implemented in a form in which an input device and an output device are integrated. For example, the output means may be configured to output a text or voice informing an occupant that a situation is not safe to get off. In addition, the output means may be configured to display information of a station other than when getting on or off, that is, during driving of the vehicle. As an example, the output means may be configured to display information related to a current number of occupants and a number of available occupants. For example, the output means may be configured to display a vehicle status, such as whether boarding is possible, when the vehicle is operating a machine (e.g., when a door is opened or closed), and an autonomous driving mode. For example, guide phases depending on situations, such as “Get on board safely!”, “Cannot board”. “Please use the next vehicle”, “The door is closed”, “The door is open”, “You are driving in autonomous driving mode”, “Please stay at least 1 m away from the vehicle” and the like may be outputted. As an example, the output means may be configured to output a guide message when the door 170 is opened or closed.

In this case, the display may comprise at least one of a liquid crystal display (LCD), a thin film transistor liquid crystal display (TFT LCD), an organic light emitting diode display (OLED display), a flexible display, a field emission display (FED), or a 3D display. For example, the interface unit 130 may be configured to perform input and output for communication with an occupant even when there is no driver. When getting off is difficult due to an external situation, the interface device 130 may be configured to make the occupant feel relieved by outputting a description of the external situation.

As an example, when manually opening and closing the door 170, the interface device 130 may be configured to notify an occupant of danger through an output of a red LED blinking, an LED color depending on a situation, periodic buzzer notification, a warning sound, or a warning message.

For example, the interface device 130 may be configured to notify an occupant of danger through an output of a red LED blinking, an LED color depending on a situation, periodic buzzer notification, a warning sound, or a warning message in a situation where the door 170 is automatically closed.

As an example, the interface device 130 may be configured to notify an occupant of danger through an output of a yellow LED blinking, periodic buzzer notification, a warning sound, or a warning message before a predetermined time from a time when the door 170 is automatically closed or opened.

For example, the interface device 130 may be configured to notify an occupant that safe getting on or off is possible through a green LED flashing and an output of a message in a state in which the door 170 is fully opened.

For example, the interface device 130 may be configured to display at least one of a vehicle status, a notification of whether the door 170 is opened or closed, or a dangerous situation around the autonomous vehicle.

The processor 140 may be electrically connected to the communication device 110, the storage 120, the interface device 130, and the like, may be configured to electrically control each component, and may be an electrical circuit that executes software commands, thereby performing various data processing and calculations described below.

The processor 140 may be configured to process signals transferred between constituent elements of the autonomous driving control apparatus 100. The processor 140 may comprise, e.g., an electronic control unit (ECU), a micro controller unit (MCU), or other subcontrollers mounted in the vehicle.

The processor 140 may be configured to control opening and closing of the door 170 of the autonomous vehicle depending on whether there is an object surrounding the door 170 of the autonomous vehicle when the autonomous vehicle 10 is stopped and whether objects outside and inside a station reach a boarding zone of the autonomous vehicle within a predetermined time. In this case, a boarding zone is a zone for an occupant to get on or off the door 170 of the vehicle 10, and may comprise a zone around door 170.

That is, when a nearby object of the autonomous vehicle 10 exists, the processor 140 may be configured to output a notification requesting to move away from the door of the autonomous vehicle through the interface device 130.

When a probability of an non-occupant object outside and inside a station (e.g., a motorcyclist or a bicyclist) reaching a boarding zone of the autonomous vehicle 10 within a predetermined time is greater than a predetermined reference level or when existence of the object is confirmed through a specific algorithm after autonomous vehicle 10 arrives at the boarding zone of the station and before opening the door, the processor 140 may be configured to wait without opening the door because there is a risk of collision between occupants getting on or off and objects outside and inside the station.

When the probability of the non-occupant object outside and inside the station (e.g., a motorcyclist or a bicyclist) reaching the boarding zone of the autonomous vehicle 10 within the predetermined time is equal to or smaller than the predetermined reference level or when it is confirmed that there is no object in the boarding area based on the specific algorithm, the processor 140 may be configured to determine that an occupant who gets on or off is safe, and may be configured to open the door to allow the occupant to board it.

That is, the processor 140 may be configured to open the door 170 when the autonomous vehicle 10 stops, there is no object around the door of the autonomous vehicle 10, and there is no object that arrives at the boarding zone of the autonomous vehicle within a predetermined time after opening the door. In this case, the predetermined time may be an expected opening waiting time.

The processor 140 may be configured to wait without closing the door even when an expected closing time arrives when a probability of an object outside and inside the station reaching the boarding zone of the autonomous vehicle 10 within a predetermined time within the expected closing time of the door of the autonomous vehicle 10 after an occupant of the autonomous vehicle 10 get on or off is greater than a predetermined reference level or when existence of the reaching object is confirmed through a specific algorithm.

The processor 140 may be configured to close the door 170 when the expected closing time arrives when the probability of the object outside and inside the station reaching the boarding zone of the autonomous vehicle 10 within the predetermined time within the expected closing time of the door of the autonomous vehicle 10 after the occupant of the autonomous vehicle 10 get on or off is equal to or smaller than the predetermined reference level or when it is confirmed that there is no object reaching the boarding area based on the specific algorithm.

The processor 140 may be configured to close the door 170 when there is no occupant getting on or off for a predetermined time after the occupant of the autonomous vehicle 10 get on or off, there is no object around the door of the autonomous vehicle 10, and there is no occupant who arrives at the boarding zone just before or immediately after a closing time.

The processor 140 may be configured to control opening or closing of the door by determining whether an object exists around the door 170 depending on whether the corresponding vehicle is stopped or whether an object outside the vehicle has reached the boarding zone of the vehicle within a short period of time (e.g., 3 s).

When an object exists in the door 170, the processor 140 may be configured to output a guide requesting a distance away from the door through the interface device 130 without opening the door. For example, the interface device 130 may be configured to output “Please stay away from the vehicle by at least 1 m”.

When no obstacle is detected within a certain distance from the outside or inside of the door within a few seconds (e.g., 5 s), the processor 140 closes the door within a short time (e.g., after 2 s) after outputting a door closing notification. However, when an obstacle is detected, the processor 140 monitors surroundings for a predetermined period of time (e.g., 5 s) after outputting a guide requesting a distance away from the door through the interface device 130 without closing the door.

In addition, the processor 140 does not close the door when it is determined that there is an occupant who will arrive at the boarding zone within a short time (e.g., 2 s) based on information received from the station system 20.

The sensing device 150 may comprise one or more sensors that sense an obstacle positioned around the host vehicle, e.g., a bicycle and a motorcycle approaching the host vehicle, and measure a distance with the obstacle and/or a relative speed thereof.

The sensing device 150 may comprise a plurality of sensors to sense an external object of the vehicle, to obtain information related to a position of the external object, a speed of the external object, a moving direction of the external object, and/or a type of the external object (e.g., vehicles, pedestrians, bicycles or motorcycles, etc.). To this end, the sensing device 150 may comprise an ultrasonic sensor, a radar, a camera, a laser scanner, and/or a corner radar, a lidar, an acceleration sensor, a yaw rate sensor, a torque measurement sensor and/or a wheel speed sensor, a steering angle sensor, etc.

The GPS receiver 160 may be configured to receive a GPS signal from a GPS to transmit it to the autonomous driving control apparatus 100, so that the autonomous driving control apparatus 100 may be configured to acquire position information of the host vehicle.

The door 170 may be controlled by the autonomous driving control apparatus 100 to perform an opening or closing operation.

The station system 20 may comprise a station control apparatus 200 and a sensing device 230, and a communication device 240.

The station control apparatus 200 may be configured to predict a movement path of an object outside and inside the station, to calculate a probability that the object outside and inside the station arrives at the boarding zone of the autonomous vehicle 10 within a predetermined time.

To this end, the station driving control apparatus 200 may comprise a storage 210 and a processor 220.

The storage 210 may be configured to store a sensing result of the sensing device 230, a communication result of the communication device 240, data and/or algorithms required for the processor 220 to operate, and the like. As an example, the storage device 210 may be configured to store a movement path of a surrounding object, the probability that the object will reach the boarding zone of the vehicle 10 within an expected door closing time or an expected door opening time. The storage 210 may comprise a storage medium of at least one type among memories of types such as a flash memory, a hard disk, a micro, a card (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic memory (MRAM), a magnetic disk, and an optical disk.

The processor 220 may be configured to predict a movement path of an object outside and inside the station, to calculate probability that the object outside and inside the station arrives at the boarding zone of the autonomous vehicle within a predetermined time.

The processor 220 may be configured to predict a movement path of an object outside and inside the station, to calculate probability that the object outside and inside the station arrives at the boarding zone of the autonomous vehicle within a predetermined time.

The processor 220 may be configured to calculate probability that the object outside and inside the station reach the boarding zone of the autonomous vehicle within a predetermined time by using at least one of the expected door opening time of the autonomous vehicle 10 received from the autonomous vehicle, the expected door closing time of the autonomous vehicle, a position of the vehicle, or the movement path of the object outside or inside the station.

The processor 220 may be configured to extract a type and a movement of the object outside and inside the station based on artificial intelligence, and may be configured to predict the movement path by using the movement of the object outside and inside the station as an input of an artificial intelligence algorithm (e.g., transformer, RNN, sequence-to-sequence, etc.).

The processor 220 may be configured to calculate probability that the object outside and inside the station reach the boarding zone within the expected door opening time or the expected door closing time.

In addition, the processor 220 may be configured to calculate the probability that the object will reach the boarding zone within a predetermined time after a door closing notification is calculated by using an average speed of the object, not an instantaneous speed of the object.

The sensing device 230 may be configured to detect the object outside and inside the station. The object includes a bicycle, a person, a motorcycle, and the like, and may comprise at least one sensor for measuring a distance, a moving direction, and/or a relative speed of the object. To this end, the sensing device 230 may comprise a camera, an ultrasonic wave sensor, a radar, a camera, a laser scanner and/or a radar, a lidar, and the like.

The communication device 240 may be configured to communicate with the vehicle 10 through wireless Internet access or a short range communication technique. Herein, the wireless communication technique may comprise wireless LAN (WLAN), wireless broadband (Wibro), Wi-Fi, world Interoperability for microwave access (Wimax), long-term evolution (LTE), etc. In addition, short-range communication technique may comprise bluetooth, ZigBee, ultra wideband (UWB), radio frequency identification (RFID), infrared data association (IrDA), and the like.

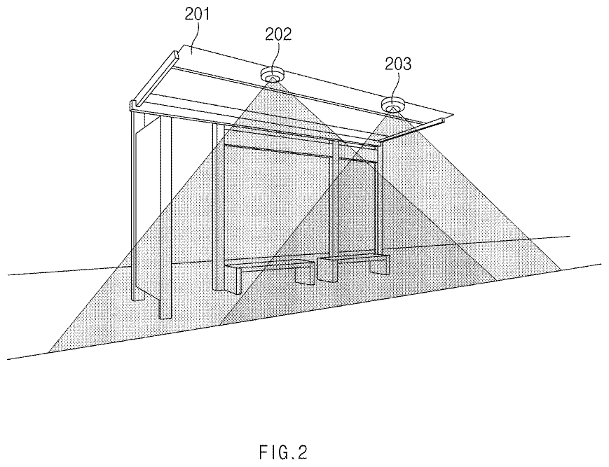

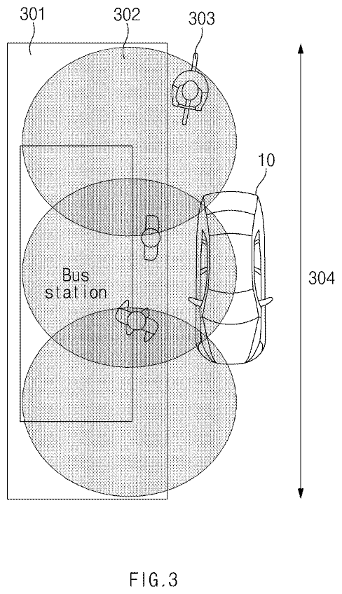

FIG. 2 illustrates an example showing a sensor installation of a station according to an exemplary embodiment of the present disclosure, and FIG. 3 illustrates a station sensing range according to an exemplary embodiment of the present disclosure.

Referring to FIG. 2, sensors 202 and 203 for sensing a movement of occupants around the station 201 may be installed at the station. Referring to FIG. 3, an occupant 303 within a sensor range 302 of a station 301 may be sensed. In this case, the sensor range may comprise a stoppable range 304 of the vehicle 10, and may comprise a wider range.

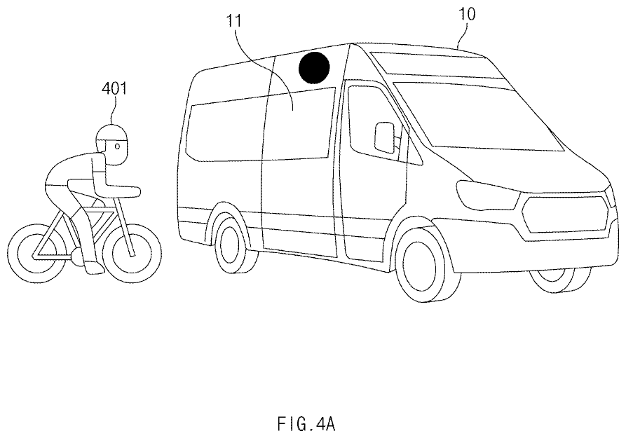

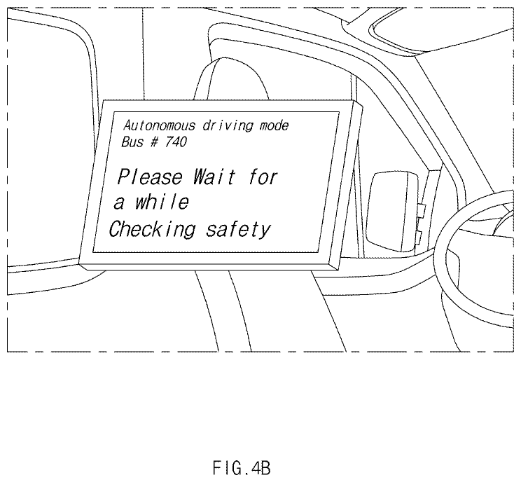

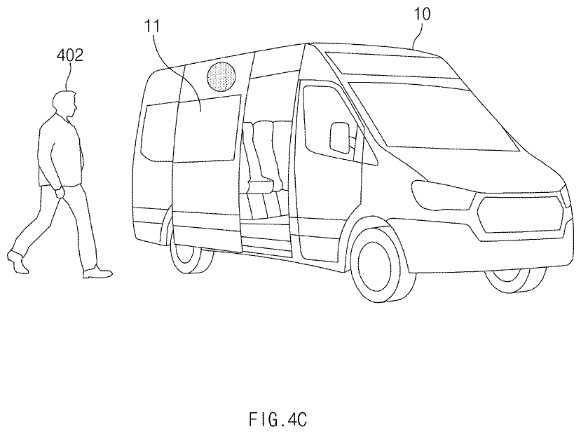

FIG. 4A illustrates an example of a screen in which a vehicle door is not opened according to an exemplary embodiment of the present disclosure, and FIG. 4B illustrates an example of a screen for notifying an occupant that a vehicle door is not opened according to an exemplary embodiment of the present disclosure. FIG. 4C illustrates an example of a screen in which a vehicle door is not closed according to an exemplary embodiment of the present disclosure.

As illustrated in FIG. 4A, the autonomous driving control apparatus 100 may be configured to determine that a situation is not safe for an occupant to get off when a probability that an object (e.g., a bicycle, a vehicle, a motorcycle, etc.) other than a person arrives in the boarding zone of the vehicle 10 at the same time that the door 170 of the vehicle 10 is opened is greater than a predetermined reference level. In this case, the predetermined reference level may be determined depending on a learning result and a situation. In addition, the boarding zone may comprise a position where an occupant gets on or off the vehicle as a door position. As such, the autonomous driving control apparatus 100 may not open the door by determining an external environment that threatens safety of an occupant, and as illustrated in FIG. 4B, and may be configured to notify the occupant in the vehicle via text or voice output that a situation is not safe to get off.

In addition, as illustrated in FIG. 4C, the autonomous driving control apparatus 100 determines that it threatens the safety of the occupant and does not close the door when a probability that a person arrives at the boarding zone of the vehicle at the time that the door 170 of the vehicle 10 is closed is greater than a predetermined reference level. In this case, the predetermined reference level may be adjusted depending on a learning result and a situation.

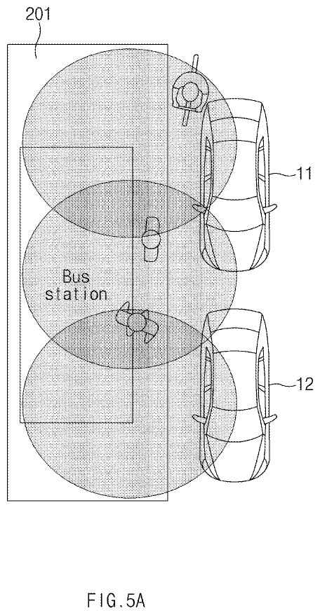

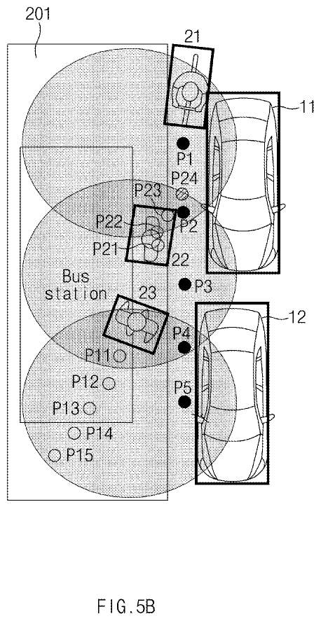

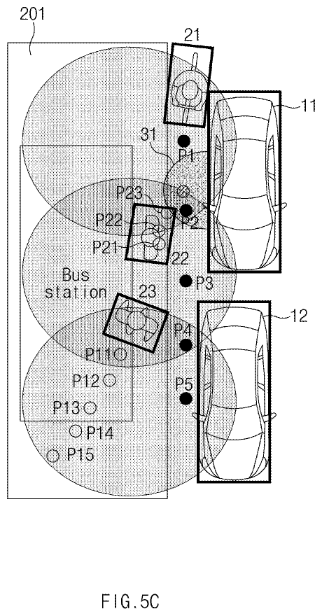

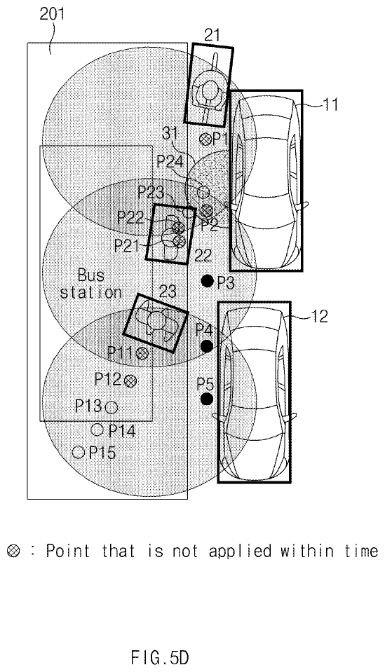

FIG. 5A to FIG. 5D illustrate an example for describing a process of calculating a probability of boarding a vehicle according to an exemplary embodiment of the present disclosure.

Referring to FIG. 5A, a sensing range of a bus station is illustrated. In this case, a camera installed on ceiling of the bus station may be configured to grasp movement of an occupant in a top-view. In this case, a view of the camera may be configured to focus on the movement of the occupant in the vehicle.

Referring to FIG. 5B, an expected path of an object within the sensing range is illustrated. In this case, the autonomous driving control apparatus 100 may be configured to predict movement of the object based on artificial intelligence. In this case, the autonomous driving control apparatus 100 may be configured to classify types of objects based on artificial intelligence. In this case, the types of the objects may comprise an occupant, a bicycle, a motorcycle, a vehicle, and the like. In addition, the autonomous driving control apparatus 100 determines the types and movements of the objects based on artificial intelligence, and stores a result to enable learning. The autonomous driving control apparatus 100 may be configured to protect an occupant getting off by opening the door of the vehicle 11 when a driving path of an object 21 (e.g., a bicycle) and a boarding zone of the vehicle 11 overlap, and by preventing a vehicle door from being opened when a probability of the object 21 reaching the boarding zone of the vehicle 11 is greater than or equal to a predetermined reference level. In this case, a predicted path of each detected object 21, 22, and 23 is predicted. The predicted path of the object 23 may be expressed as points P11, P12, P13, P14, and P15, and is moving in a direction from P11 to P15. The predicted path of the object 21 may be displayed as points P1, P2, P3, P4, and P5, and the object that is not an occupant of the vehicle 10 is displayed separately from the occupant through discrimination such as colors and hatching of the points. The predicted path of the object 22 is expressed as points such as P21, P22, P23, and P24. In this case, each point may be displayed in units of 1 second.

Referring to FIG. 5C, the autonomous driving control apparatus 100 matches positions of vehicles on image data captured based on a camera by using position information of each vehicle received from the vehicles 11 and 12.

The vehicle 10 calculates an expected closing time of the door and transmits it to the station system 20.

Accordingly, the station system 20 analyzes and/or tracks movement paths of the objects 21, 22, and 23, and calculates a probability that the objects 21, 22, and 23 will reach a boarding zone 31 within an expected door closing time.

Referring to FIG. 5D, the object 21 passes the boarding zone 31 at the expected closing time of the door, so that the point P2 is displayed in a different color from a previous point.

The object 22 arrives at the boarding zone 31 at the expected closing time of the door. That is, the object 22 moves point positions P21 and P22 to positions P23 and P24 after an expected door closing time (e.g., 2 s), and the position P24 overlaps the boarding zone 31. Accordingly, the station system 20 may be configured to determine that there is a high probability that the object 22 will reach the boarding zone 31 within the expected closing time of the door. Meanwhile, when the object 23 moves in a direction away from the vehicle 11 and it reaches the expected door closing time, the points P11 and P12 do not have values, and the object 21 is positioned at the point P13.

The station system 20 transmits to the autonomous driving control apparatus 100 a probability that the object 22 will reach the boarding zone 31 within the expected closing time of the door, and the autonomous driving control apparatus 100 controls the door of the vehicle 11 to not be closed when the probability that the object 22 will reach the boarding zone 31 within the expected closing time of the door is greater than a predetermined reference level. Accordingly, when an occupant arrives at the expected door closing time, there are cases where the occupant trying to board may be injured while the door of the vehicle is closed, and as described above, the autonomous driving control apparatus 100 may be configured to predict in advance a probability that the occupant will arrive in time for the expected door closing time, and may be configured to ensure safety of the occupant by waiting without closing the door when a probability of presence of an occupant arriving at the expected door closing time is higher than a reference level. In this case, a waiting time may be within a predetermined time (e.g., 2 s) from the expected door closing time.

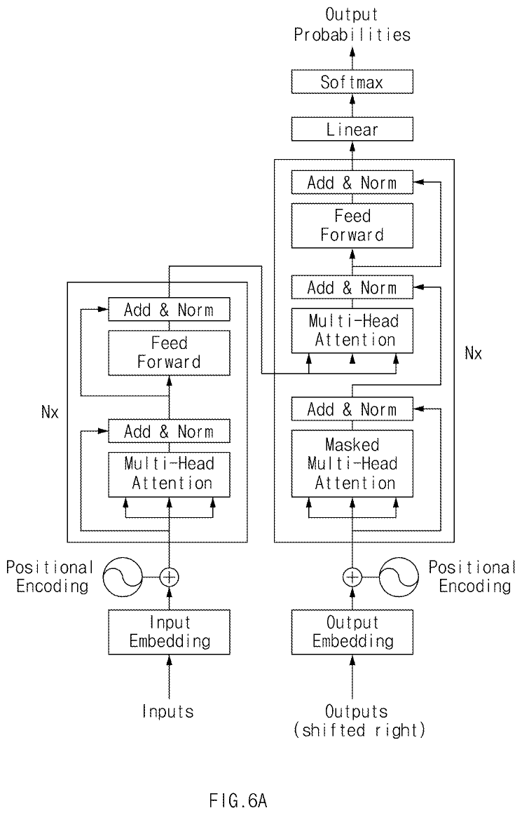

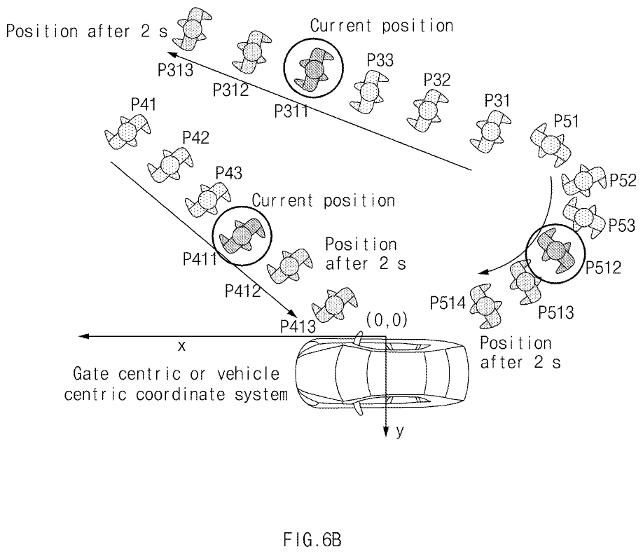

FIG. 6A illustrates an example of a transformer which is an artificial intelligence model that can be used as an example of a movement prediction method of an object according to an exemplary embodiment of the present disclosure, and FIG. 6B illustrates a view for describing a movement prediction process of an object using an artificial intelligence model other than a transformer according to an exemplary embodiment of the present disclosure.

The present disclosure discloses an example of using a transformer as a model of artificial intelligence, but is not limited thereto, and artificial intelligence models such as a recurrent neural network (RNN), sequence to sequence (seq2seq), and convolutional neural network (CNN) may be used.

A movement of the occupant may vary depending on a movement of a surrounding object, a structure of the station, obstacles, etc., and they affect movements of each other. Accordingly, the station system 20 of the present disclosure uses a transformer as in FIG. 6A as a model that can entirely learn it.

The station system 20 may be configured to calculate a weight of how much they affect each other among occupants through attention, may be configured to extract various characteristics of how each object affects through multi-head attention, and may be configured to combine them to compute complex interrelationships. In addition, the artificial intelligence models are optimized for each station. As a result, even occupants who are not visible from each other may be identified from a top-view in the vehicle, and there is a pattern in which the occupants are seen at the corresponding station. That is, the structure of the station and behavioral patterns of people who frequently appear at the station exist. Data of these artificial intelligence models may continuously be collected and stored to be automatically updated, thereby realizing the artificial intelligence model and applying it to object movement prediction.

Referring to FIG. 6B, the station system 20 predicts a movement of an object around the vehicle 10 based on a transformer model. As a movement path of the object away from the vehicle, points P31, P32, and P33 are movement paths of the object for 3 s, and after 3 s, the object is positioned at P311 and moves through P312 and P313 after 2 s.

Further, as a movement path of the object toward the vehicle, points P41, P42, and P43 are movement paths of the object for 3 s, and after 3 s, the object, is positioned at P411 and moves through P412 and P413 after 2 s.

In addition, as a movement path of the object that is bypassed toward the vehicle, points P51, P52, and P53 are movement paths of the object for 3 s, and after 3 s, the object, is positioned at P511 and moves through P512 and P513 after 2 s.

As such, the station system 20 may be configured to predict a movement path of an object moving in a direction away from the vehicle, a direction bypassing the vehicle, and a direction toward the vehicle based on center coordinates (0, 0) of the vehicle.

For example, it is possible to predict a path for next 10 s based on 10 s of data.

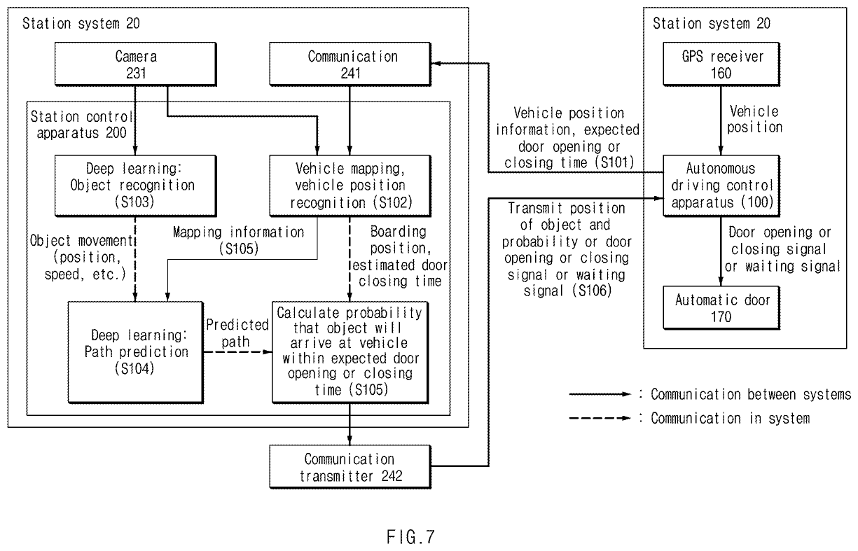

Hereinafter, a process of a system for automatic door control of a vehicle according to an exemplary embodiment of the present disclosure will be described in detail with reference to FIG. 7. FIG. 7 illustrates an operation flowchart of a system for a door automatic control for a vehicle according to an exemplary embodiment of the present disclosure.

Referring to FIG. 7, when the vehicle 10 stops at a station, position information of the vehicle and expected door closing time information are transmitted to the station system 20 (S101).

Accordingly, a communication receiver 241 transmits the vehicle position information and the expected door closing time information received from the vehicle 10 to the stop control device 200 by using communication such as LTE or Bluetooth, and the stop control apparatus 200 may be configured to determine a vehicle position by matching the vehicle position received from the vehicle 10 with a vehicle position on image data related to outside and inside of the station by a camera 231 (S102). In this case, the expected door closing time information indicates an expected door closing time of the vehicle, and the expected door opening time information indicates an expected door opening time. For example, when the door closes after 1 min, the expected closing time is 1 min.

Meanwhile, the camera 231 of the station system 20 transmits the image data related to the outside and inside of the station to the station control apparatus 200. Accordingly, the station control apparatus 200 recognizes a type of object (e.g., an occupant, a bicycle, a motorcycle, etc.) and a movement (e.g., a direction, a speed, etc.) of the object based on the image data and artificial intelligence received from the camera 231 (S103). That is, the station control apparatus 200 may be configured to predict the movement of the object for a next predetermined time by inputting the movement of the object as an input of an artificial intelligence algorithm.

The station control apparatus 200 predicts a path of the object based on artificial intelligence by using information related to the type of object and the movement of the object (S104).

Accordingly, the station control device 200 calculates a probability that the object will arrive at the boarding zone within the expected door opening or closing time of the vehicle by using the predicted path and the expected door opening or closing time (S105).

Then, the station control device 200 may be configured to transmit the position of the object and probability data that the object will arrive at the boarding zone within the expected door opening or closing time of the vehicle to the vehicle 10 (S106). In addition, the station control apparatus 200 may be configured to transmit to the vehicle 10 a vehicle door opening or closing command signal, or a waiting signal to wait for opening or closing before operation by determining whether a probability that the object will arrive at the boarding zone within the expected door opening or closing time of the vehicle is greater than a predetermined reference level. Accordingly, the vehicle 10 may be configured to control opening or closing of the door.

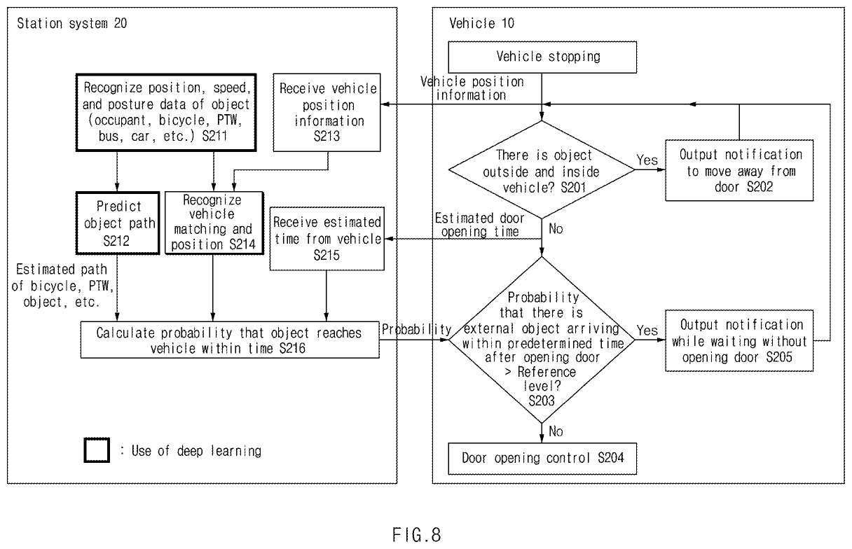

Hereinafter, a method for automatically opening a door for a vehicle according to an exemplary embodiment of the present disclosure will be described in detail with reference to FIG. 8. FIG. 8 illustrates a flowchart showing a method for automatically opening a door for a vehicle according to an exemplary embodiment of the present disclosure.

Hereinafter, it is assumed that the autonomous driving control apparatus 100 of the of FIG. 1 performs processes of FIG. 8. In addition, in the description of FIG. 8, operations described as being performed by a device may be understood as being controlled by the processor 140 of the autonomous driving control apparatus 100 of the.

Referring to FIG. 8, the vehicle 10 transmits position information of the host vehicle to the station system 20, and after the vehicle 10 is stopped, determines whether an obstacle exists outside or inside the vehicle (S201).

When the obstacle exists outside and inside the vehicle 10, the vehicle 10 outputs a notification to nearby objects to move away from the door of vehicle 10.

In addition, when a probability that the object will arrive at the boarding zone of the vehicle 10 within a door opening time exceeds a predetermined reference level or existence of the object is definitely determined, the vehicle 10 outputs a notification asking an occupant to wait for a while to get on or off due to an obstacle (S202).

Meanwhile, when no obstacle exists outside or inside the vehicle, the vehicle 10 transmits an expected door opening time of the vehicle to the station system 20, and after opening the door of the vehicle 10, receives from the station system 20 a probability that or whether an external object arrives within a predetermined time to determine whether the probability exceeds a predetermined reference level (S203).

When the probability does not exceed the predetermined reference level or it is definitely determined that the external object does not exist due to a specific algorithm, the vehicle 10 performs door opening control (S204). On the other hand, when the probability exceeds the predetermined reference level, the vehicle 10 notifies that the door is waiting to be opened around the vehicle while waiting without performing the door opening control (S205).

Meanwhile, the station system 20 determines a position, a speed, posture data of the object, etc. based on image information by, e.g., a camera (S211), and predicts a path of the object based on information related to the position, the speed, and the posture data of the object, etc. (S212). In this case, the station system 20 may be configured to perform the above steps S211 and S212 based on artificial intelligence.

In addition, the station system 20 receives position information of the vehicle (S213), identifies the position of the vehicle by matching the position information of the vehicle with a vehicle position of image data of a camera (S114), receives the expected door closing time received from the vehicle 10 (S115), and calculates the probability that the object will arrive at the boarding zone of the vehicle within a predetermined time based on the expected door opening time received from the vehicle and the path of the object (S216).

Thereafter, the station system 20 may be configured to transmit to the vehicle 10 the probability that the object will arrive at the boarding zone of the vehicle 10 within the predetermined time, and the vehicle 10 determines whether the probability that the object will arrive at the boarding zone of the vehicle 10 within the predetermined time exceeds a predetermined reference level, so as to determine whether the door opening control is performed.

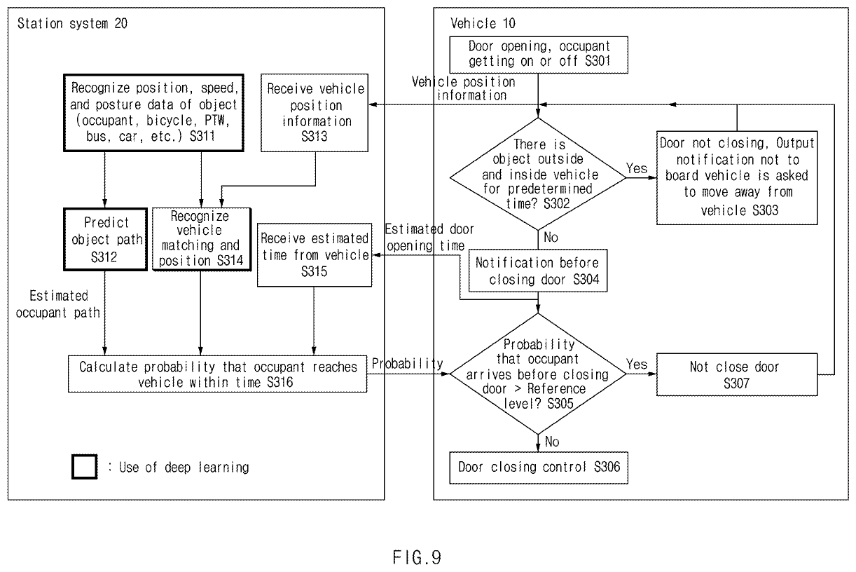

Hereinafter, a method for automatically closing a door for a vehicle according to an exemplary embodiment of the present disclosure will be described in detail with reference to FIG. 9. FIG. 9 illustrates a flowchart showing a control method for automatically closing a door for a vehicle according to an exemplary embodiment of the present disclosure.

Hereinafter, it is assumed that the autonomous driving control apparatus 100 of the of FIG. 1 performs processes of FIG. 9. In addition, in the description of FIG. 9, operations described as being performed by a device may be understood as being controlled by the processor 140 of the autonomous driving control apparatus 100.

Referring to FIG. 9, an occupant gets on or off after a door of vehicle 10 is opened (S301), the vehicle 10 transmits position information of the host vehicle to the station system 20, and it is determined whether an object exist outside and inside the vehicle for a predetermined time after the occupant gets on or off (S302).

When the object exists outside and inside the vehicle 10, the vehicle 10 outputs a notification requesting that a person not to board the vehicle 10 is asked to move away from the door of the vehicle 10 for safety without closing the door (S303).

In the meantime, when the object does not exist outside and inside the vehicle 10, the vehicle 10 outputs a notification that the door will be closed before closing the door (S304). Thereafter, the vehicle 10 transmits an expected door closing time of the vehicle to the station system 20, and determines whether a probability that the occupant will arrive before the door of the vehicle 10 is closed exceeds a predetermined reference level (S305). In this case, the probability that the occupant will arrive before the door is closed may be received from the station system 20.

When the probability does not exceed the predetermined reference level, the vehicle 10 performs door closing control (S306). On the other hand, when the probability exceeds the predetermined reference level, the vehicle 10 waits without performing the door closing control (S307).

Meanwhile, the station system 20 determines a position, a speed, posture data of the object, etc. based on image information by, e.g., a camera (S311), and predicts a path of the object based on information related to the position, the speed, and the posture data of the object, etc. (S312). In this case, the station system 20 may be configured to perform the above steps S311 and S312 based on artificial intelligence.

In addition, the station system 20 receives position information of the vehicle (S313), identifies the position of the vehicle by matching the position information of the vehicle with a vehicle position of image data of a camera (S314), receives the expected door closing time received from the vehicle 10 (S315), and calculates the probability that the occupant will arrive at the boarding zone of the vehicle within a predetermined time based on the expected door closing time and the path of the object (S316).

Thereafter, the station system 20 may be configured to transmit to the vehicle 10 the probability that the object will arrive at the boarding zone of the vehicle within the predetermined time, and the vehicle 10 determines whether the probability that the occupant will arrive at the boarding zone of the vehicle 10 within the predetermined time exceeds a predetermined reference level, so as to determine whether the door closing control is performed.

As such, according to the present disclosure, even when there is no driver inside, it is possible to get on or off safely by controlling opening and closing of the door by recognizing movement of surrounding objects during fully autonomous driving.

In addition, according to the present disclosure, user convenience may be increased by automating door opening and closing through communication between the station system and the vehicle, and even when a driver is not present, a gap caused by absence of the driver may be reduced by communicating with the occupant of the vehicle.

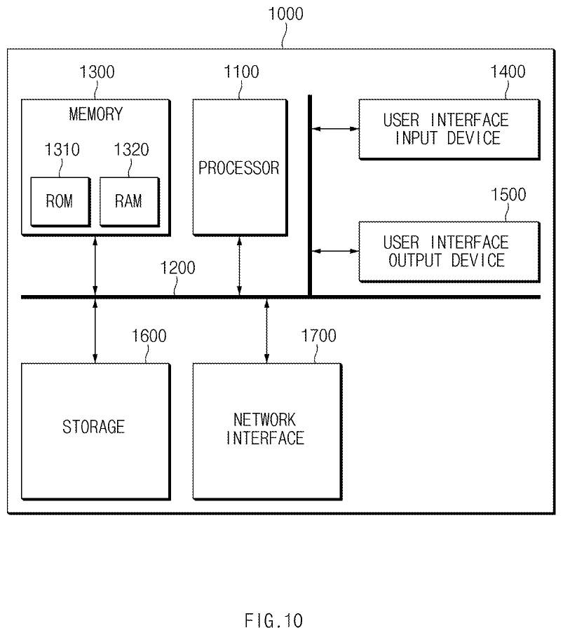

FIG. 10 illustrates a computing system according to an exemplary embodiment of the present disclosure.

Referring to FIG. 10, the computing system 1000 includes at least one processor 1100 connected through a bus 1200, a memory 1300, a user interface input device 1400, a user interface output device 1500, and a storage 1600, and a network interface 1700.

The processor 1100 may be a central processing unit (CPU) or a semiconductor device that performs processing on commands stored in the memory 1300 and/or the storage 1600. The memory 1300 and the storage 1600 may comprise various types of volatile or nonvolatile storage media. For example, the memory 1300 may comprise a read only memory (ROM) 1310 and a random access memory (RAM) 1320.

Accordingly, steps of a method or algorithm described in connection with the exemplary embodiments disclosed herein may be directly implemented by hardware, a software module, or a combination of the two, executed by the processor 1100. The software module may reside in a storage medium (i.e., the memory 1300 and/or the storage 1600) such as a RAM memory, a flash memory, a ROM memory, an EPROM memory, an EEPROM memory, a register, a hard disk, a removable disk, and a CD-ROM.

An exemplary storage medium is coupled to the processor 1100, which can read information from and write information to the storage medium. Alternatively, the storage medium may be integrated with the processor 1100. The processor and the storage medium may reside within an application specific integrated circuit (ASIC). The ASIC may reside within a user terminal. Alternatively, the processor and the storage medium may reside as separate components within the user terminal.

The above description is merely illustrative of the technical idea of the present disclosure, and those skilled in the art to which the present disclosure pertains may make various modifications and variations without departing from the essential characteristics of the present disclosure.

Therefore, the exemplary embodiments disclosed in the present disclosure are not intended to limit the technical ideas of the present disclosure, but to explain them, and the scope of the technical ideas of the present disclosure is not limited by these exemplary embodiments. The protection range of the present disclosure should be interpreted by the claims below, and all technical ideas within the equivalent range should be interpreted as being included in the scope of the present disclosure.

What is claimed is:

1. An autonomous vehicle comprising:
a processor configured to control opening and closing of a door of an autonomous vehicle depending on existence of an object around the door of the autonomous vehicle and whether an object outside and inside a station reaches a boarding zone of the autonomous vehicle within a predetermined time when the autonomous vehicle is stopped; and
a storage configured to store data and algorithms driven by the processor.

2. The autonomous vehicle of claim 1, further comprising an interface device configured to display one or more of the following:
at least one of a vehicle status;
a notification of whether the door is opened or closed; and
a dangerous situation around the autonomous vehicle.

3. The autonomous vehicle of claim 2, wherein the processor is further configured to output a notification requesting a distance away from the door of the autonomous vehicle through the interface device when a surrounding object of the autonomous vehicle exists.

4. The autonomous vehicle of claim 2, wherein the interface device is further configured to notify an occupant of danger by outputting one or more of the following:
an LED blinking;
an LED color depending on a situation;
a periodic buzzer notification;
a warning sound; and
a warning message within a predetermined time from a situation where the door is automatically or manually closed, or from a time the door is automatically opened or closed.

5. The autonomous vehicle of claim 2, wherein the interface device is further configured to inform an occupant that getting on or off is possible through LED lighting or output of a guide message in a state where the door is fully opened.

6. The autonomous vehicle of claim 1, further comprising a communication device configured to:
communicate with a station system;
transmit one or more of the following:
position information of the vehicle;
boarding gate position information; and
expected door opening or closing time information to the station system; and
receive from the station system whether an object outside and inside the station system reaches the boarding zone of the autonomous vehicle within a predetermined time or estimated time data for an object to arrive at the boarding zone of the autonomous vehicle.

7. The autonomous vehicle of claim 1, wherein the processor is further configured to wait without opening the door when:
the autonomous vehicle stops; and
a probability that an object outside and inside the station will reach the boarding zone of the autonomous vehicle within a predetermined time before opening the door is greater than a predetermined reference level; or
existence of the object outside and inside the station, other than an occupant, is confirmed.

8. The autonomous vehicle of claim 1, wherein the processor is further configured to determine that the door is openable when:
the autonomous vehicle stops; and
a probability that an object outside and inside the station will reach the boarding zone of the autonomous vehicle within a predetermined time before opening the door is equal to or smaller than a predetermined reference level; or
no object exists around outside of the door of the autonomous vehicle.

9. The autonomous vehicle of claim 1, wherein the processor, after an occupant gets on or off the autonomous vehicle, is further configured to wait, without closing the door, even when an expected door closing time arrives, when:
a probability that an object outside and inside the station will reach the boarding zone of the autonomous vehicle within a predetermined time before closing the door is greater than a predetermined reference level; or
existence of the object outside and inside the station other than an occupant is confirmed.

10. The autonomous vehicle of claim 1, wherein the processor, after an occupant gets on or off the autonomous vehicle, is further configured to determines that the door is closeable when:
an expected door closing time arrives when a probability that an object outside and inside the station will reach the boarding zone of the autonomous vehicle within a predetermined time before closing the door is equal to or smaller than a predetermined reference level; or
it is determined that no object outside and inside the station other than an occupant exists.

11. A station system comprising:
a processor configured to calculate information that is a determining factor in:
determining whether to open or close an automatic door of an autonomous vehicle by classifying a type of an object outside and inside a station; and
predicting a movement path of the object; and
a communication device configured to perform one or more of the following:
receive information necessary to calculate information serving as the determining factor from the autonomous vehicle; and
transmit the information, calculated by the processor, to the autonomous vehicle.

12. The station system of claim 11, wherein the information that is the determining factor in determining whether to open or close the automatic door of the autonomous vehicle comprises one or more of the following:
a probability that the object outside and inside the station will reach a boarding zone of the autonomous vehicle within a predetermined time;
whether the object outside and inside the station reaches the boarding zone of the autonomous vehicle within a predetermined time; and
an estimated arrival time of an object approaching the autonomous vehicle.

13. The station system of claim 11, wherein the processor is further configured to perform one or more of the following:
classify the type of the object outside and inside the station;
track the movement path of the object; and
extract a movement of the object.

14. The station system of claim 11, wherein the processor is further configured to predict the movement path by using a movement of the object outside and inside the station as an input of an artificial intelligence algorithm.

15. The station system of claim 11, further comprising a sensing device configured to sense the object outside and inside the station.

16. The station system of claim 15, wherein the processor is further configured to map;
a vehicle position received from the autonomous vehicle; and
a vehicle position sensed by the sensing device.

17. The station system of claim 11, wherein the processor is further configured to:
receive a boarding gate position from the autonomous vehicle;
recognize the boarding gate position of the vehicle; and
set a boarding zone based on a received vehicle position.

18. The station system of claim 11, wherein the processor is further configured to:
calculate a probability that or whether an object outside and outside a station arrives at a boarding zone of the autonomous vehicle within a predetermined time by using one or more of the following:
an expected door opening time of the autonomous vehicle received from the autonomous vehicle;
an expected door closing time of the autonomous vehicle;
a position of the vehicle; and
a movement path of the object outside and inside the station, and
calculate an estimated time of the object approaching the vehicle by using one or more of the following:
the position or the boarding zone of the autonomous vehicle received from the autonomous vehicle; and
the movement path of the object outside and inside the station.

19. A door control method for an autonomous vehicle, comprising:
determining whether an object surrounding a door of the autonomous vehicle exists when the autonomous vehicle is stopped; and
controlling opening and closing of the door of the autonomous vehicle depending on:
existence of the object around the door; and
whether an object outside and inside a station reaches a boarding zone of the autonomous vehicle within a predetermined time.

20. The door control method of claim 19, further comprising displaying one or more of the following:
a vehicle status;
whether the door is opened or closed;
an expected opening or closing notification of the door; and
a dangerous situation around the autonomous vehicle.
